(19) United States
(12) Patent Application Publication
(10) Pub. No.: US 2012/0197781 A1
(43) Pub. Date: Aug. 2, 2012

(54) ADVANCE BLOCKING AND PAYMENT HOLDING STRATEGIES

(75) Inventors: Brian J. Valetutti, Elkton, MD (US); Thomas Anderson, Clover, SC (US); Carmie Cheatham, Tampa, FL (US); Sharon R. Connelly, San Anselmo, CA (US); James H. Grant, Charlotte, NC (US); Patricia Hanson, Garland, TX (US); Julie C. Murphy, Charlotte, NC (US)

(73) Assignee: BANK OF AMERICA CORPORATION, Charlotte, NC (US)

(21) Appl. No.: 13/018,284

(22) Filed: Jan. 31, 2011

(51) Int. Cl. G06Q 40/00

(52) U.S. Cl. 705/38

(57) ABSTRACT

Embodiments of the invention are directed to systems, methods and computer program products for identifying risk patterns for accounts based on a plurality of rules, and executing risk mitigation routines for those accounts for which risk patterns have been identified. If an advance block risk pattern is identified for an account, an advance block routine is executed for the account. If a payment hold risk pattern is identified for an account, a payment hold routine is executed for the account.

### BACKGROUND

Risk may be defined in a business environment as an event, situation or condition that may occur and if it occurs, will impact the ability of a business to achieve its desired objectives. Risk management involves: (1) defining events, situations, or conditions and the potential impact to the business, clients, and/or the like; (2) detecting those defined events when they occur; (3) executing a pre-defined set of actions to minimize negative impacts based upon the level of threat and client impact of mitigation alternatives (e.g., risk mitigation, prevention and the like); and (4) when unable to prevent a risk event from negatively impacting, executing a set of actions to recover all or part of the loss. In some cases, recovery includes taking legal action against the entity causing the loss.

In the financial world, risk management is necessary in various aspects of the business. Financial institutions manage various forms of risk. One such risk is credit risk, which is a risk related to the inability of a client, customer, or other party to meet its repayment or delivery obligations under previously agreed upon terms and conditions around credit (e.g., a loan, a line of credit, or the like) provided to the party. Credit risk can also arise from operational failures that result in an advance being provided to a customer that should not be advanced the funds.

A financial institution may suffer losses when a client's repayment obligation is overdue. A financial institution may also suffer losses when a client, as part of its repayment obligation, makes a payment that cannot be collected. For instance, the client may issue a bad check either fraudulently or inadvertently because of clerical error. Worse still is when the client issues a bad check and the financial institution provides new credit to the client in reliance on the client's check.

For all these reasons and others, there is a need for a financial institution to devise a strategy to identify clients, accounts, or transactions that may fit risk patterns which may result in financial losses. There is also a need to devise a strategy to mitigate the financial losses that may result from these identified risks.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention address the above needs and/or achieve other advantages by providing apparatuses (e.g., a system, computer program product, and/or other device), methods, or a combination of the foregoing for identifying risk patterns for accounts based on a plurality of rules, and then executing risk mitigation routines for those accounts for which risk patterns have been identified. The risk mitigation routines may mitigate the financial losses that may result from the identified risk patterns.

For example, some embodiments of the invention provide a method for risk monitoring and mitigation. The method includes receiving, via a computing device processor, account data for an account. The method further includes monitoring, via a computing device processor, the account data to identify one or more risk patterns. The method further includes identifying, via a computing device processor, the one or more risk patterns. The method further includes, in response to identifying an advance block risk pattern based on at least on one blocking rule, automatically executing, via a computing device processor, an advance block routine. The method further includes, in response to identifying a payment hold risk pattern based on at least one holding rule, automatically executing, via a computing device processor, a payment hold routine.

In some embodiments of the method, identifying a payment hold risk pattern based on at least one holding rule further includes determining, via a computing device processor, whether a payment is made to the account. The method further includes, in response to determining the payment is made to the account, determining, via a computing device processor, whether there is a delay in collecting the payment. The method further includes determining, via a computing device processor, whether the account is eligible for an override. The method further includes determining, via a computing device processor, whether the account is associated with an excluded product.

In some embodiments of the method, identifying an advance block risk pattern based on at least one blocking rule further includes determining, via a computing device processor, whether the account is delinquent, wherein the account is delinquent if a payment on the account has been due for a pre-determined number of days.

In some embodiments of the method, the method further includes in response to either executing the advance block routine or the payment hold routine, automatically executing, generating and initiating communication of, via a computing device processor, a risk alert for the account.

In some embodiments of the method, executing the advance block routine further includes automatically blocking the account, via a computing device processor, from participating in one or more transactions. In specific embodiments, the one or more transactions is a credit advancing transaction. In specific embodiments, the method further includes determining, via a computing device processor, whether the advance block risk pattern is removed, and in response to determining the advance block risk pattern is removed, automatically unblocking the account, via a computing device processor.

In some embodiments of the method, executing the payment hold routine further includes determining, via a computing device processor, whether a payment is made to the account, and automatically holding, via a computing device processor, the payment made to the account. In specific embodiments, the method further includes determining, via a computing device processor, whether the payment hold risk pattern is removed, and in response to determining the payment hold risk pattern is removed, automatically removing, via a computing device processor, the hold on the payment.

Embodiments of the invention also provide a system for risk monitoring and mitigation. The system includes a computing platform including at least one processor and a memory. The system also includes a module, or more than one module, stored in the memory, executable by the processor, and configured to execute the various embodiments of the method described above.

Embodiments of the invention also provide a computer program product for risk monitoring and mitigation. The computer program product includes a non-transitory computer-readable medium including a set of codes for causing a computer to execute the various embodiments of the method described above.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a block diagram of a system configured to monitor payment hold and advance block risk patterns, and execute payment hold and advance block routines, in accordance with embodiments of the present invention;

FIG. 2 is a flowchart for monitoring and mitigating risk associated with accounts, in accordance with embodiments of the present invention; and

FIG. 3 is a flowchart displaying a method for identifying a payment hold risk pattern, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

In general, embodiments of the present invention relate to systems, methods and computer program products for identifying, based on a plurality of rules, risk patterns for accounts, and executing risk mitigation routines for those accounts for which risk patterns have been identified.

For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. An “account” may be the relationship that an individual or a first entity such as a business organization, hereinafter referred to as the “client” or “account holder,” has with a second entity, which may be a financial institution. This account may be a credit account such that the client has a repayment or delivery obligation towards a second entity under previously agreed upon terms and conditions. A “transaction” may be monetary in nature (e.g., a purchase via a credit card; depositing a check in an account; requesting an advance; a stock trade or the like) or non-monetary in nature (e.g., a telephone call; an encounter with a financial institution or non-financial institution associate/representative; an identity authentication process, such as a biometric identity authentication process; recorded use of a utility, such as electricity and the like).

In accordance with embodiments of the invention, the term “module” with respect to a system may refer to a hardware component of the system, a software component of the system, or a component of the system that comprises both hardware and software.

The plurality of rules for identifying risks may be executed using financial institution data and non-financial institution data. The financial institution data may include transactional level data, such as checking transactions, ATM transactions, and credit/debit card transactions that allow for determination of a client's transactional behaviors. Additionally, the financial institution data may include account data, such as account balances and the like, and client data, such as personal data, profile data, demographics data, contact information, and the like. More specifically, the financial institution data may include the age of the account, payment history, payment terms, payment sizes of both current and past payments, payment sources of both current and past payments, payment due dates and whether the client is meeting the payment due dates, the number of days overdue if a payment is overdue, whether any past payments have been returned for any reason other than error on part of the financial institution that manages the account, the type of loan product associated with the account, whether the loan product is unsecured or secured, the guarantors of an account, whether any risk mitigation actions have previously been executed on the account, payment history of other associated accounts, any remarks associated with the account or associated accounts, etc. In addition, data may be collected from non-financial institutions, such as consumer bureaus, business bureaus, retailers (online and brick & mortar) government agencies, Internet Service Providers (ISPs), telephone companies (Telcos), health care industry entities, and the like. The information obtained from consumer bureaus may include payment status on bills, payment status on accounts at other financial institutions, credit utilization ratios, length and variety of credit history, instances of credit inquiries, instances of charge-offs, instances of bankruptcy filings, instances of other delinquencies, or the like. If the client is an entity, the information from business bureaus may include bankruptcy filings, payment disputes with customers, payment of dues to business bureaus, information provided to business bureaus or the like. If the client is an entity, the non-financial information may provide additional transactional information regarding the holder of an account, such as the type of business or operation that the client is engaged in, the reputation of the client, etc. If the client is an individual, the non-financial information may include the type of items purchased by the client and the like, behavioral data, such as purchasing or browsing behaviors of the client, etc. The financial institution data and non-financial institution data may be captured in one or more risk databases that allow for analytics and/or logic to be performed on the data for the purpose of leveraging the collected data to define various risk patterns and execute various routines/logic to mitigate the risks associated with identified risk patterns.

### System Environment

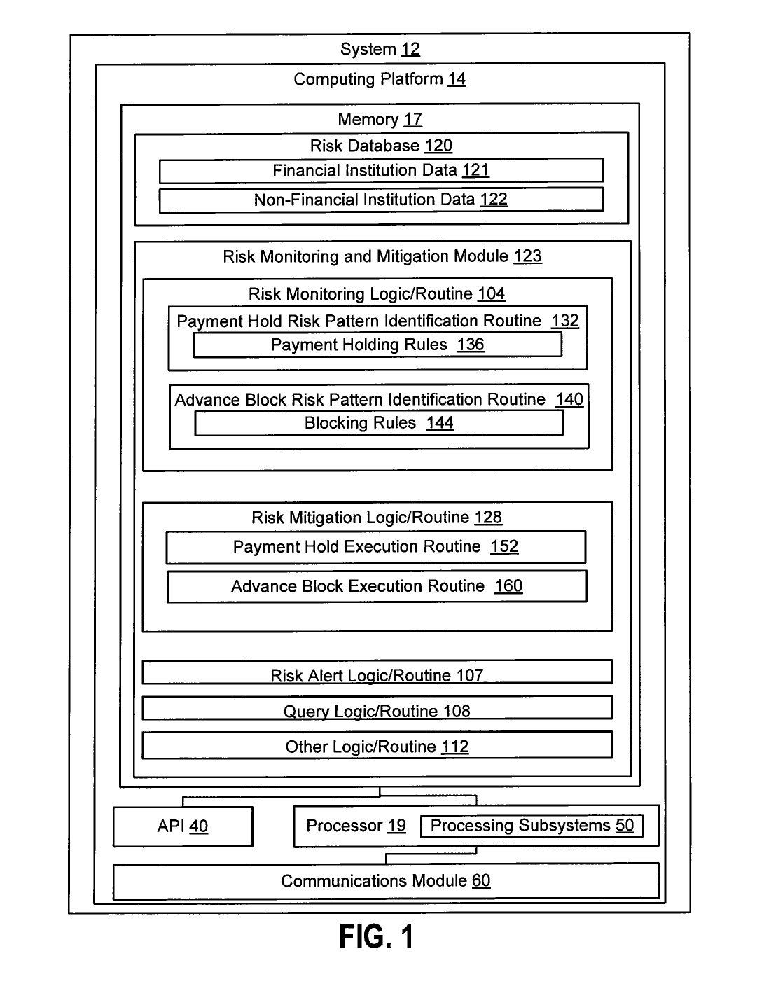

FIG. 1 is a block diagram of a system 12 configured to monitor payment hold and advance block risk patterns, and execute payment hold and advance block routines, in accordance with embodiments of the present invention. The system 12 may include a computing platform 14 having a memory 17 and at least one processor 19 that is in communication with the memory 17. The memory 17 may comprise volatile and non-volatile memory, such as read-only and/or random-access memory (RAM and ROM), EPROM, EEPROM, flash cards, or any memory common to computer platforms. Further, the memory 17 may include one or more flash memory cells, or may be any secondary or tertiary storage device, such as magnetic media, optical media, tape, or soft or hard disk.

The processor 19 may be an application-specific integrated circuit (“ASIC”), or other chipset, processor, logic circuit, or other data processing device. The processor 19 or other processor such as ASIC may execute an application programming interface (“API”) 40 that interfaces with any resident programs, such as the risk monitoring and mitigation module 123 and related applications/routines and/or logic or the like stored in the memory 17 of the system 12.

The processor 19 may include various processing subsystems 50 embodied in hardware, firmware, software, and combinations thereof, that enable the functionality of the system 12 and the operability of the system 12 on a network. For example, the processing subsystems 50 may allow for initiating and maintaining communication and exchanging data with other networked devices. For the disclosed aspects, the processing subsystems 50 of processor 19 may include any subsystem used in conjunction with the risk monitoring and mitigation module 123 or the like or subcomponents or sub-modules thereof.

The system 12 may additionally include a communications module 60 embodied in hardware, firmware, software, and combinations thereof, that enables communication among the various components of the system 12, as well as between the other devices in the network. Thus, the communications module 60 may include the requisite hardware, firmware, software and/or combinations thereof for establishing a network communication connection. It should be appreciated that the communications module 60 may be the mechanism through which users of the system submit queries to the system 12. It should also be appreciated that the communications module 60 may be the mechanism through which embodiments of the present invention sends alerts/reports/scores/data to configured recipients, personnel, and the like.

The memory 17 may include a risk monitoring and mitigation module 123 that is executable by the processor 19. The risk monitoring and mitigation module 123 may receive or access financial institution data 121 and/or non-financial institution data 122 that may be a collected at a risk database 120. The risk database 120 may be a centralized database or it may represent one or more remote databases. The financial institution data 121 and non-financial institution data 122 have been described earlier. In one embodiment, the risk monitoring and mitigation module 123 may also receive or access risk identification rules, such as payment holding rules and advance blocking rules, which may be collected at a centralized rules database or at one or more remote rules databases.

The risk monitoring and mitigation module 123 may include a plurality of logic/routines configured to identify risk patterns and mitigate the identified risks based on the use of the data collected in the risk database 120 and accessible by the risk monitoring and mitigation module 123. The logic/routines shown in FIG. 1 are by way of example only and, as such, the risk monitoring and mitigation module 123 may include more or less logic/routines as dictated by the implementation of the system 12.

As stated earlier, the memory 17 may store a risk monitoring and mitigation module 123. In specific embodiments, the risk monitoring and mitigation module 123 may comprise a risk monitoring logic/routine 104 that is configured to identify one or more risk patterns associated with an account, such as a credit account. The risk monitoring logic/routine 104 may include a payment hold risk pattern identification logic/routine 132 which may access one or more holding rules 136. The holding rules may be integrated into the payment hold risk pattern identification logic/routine 132 or the holding rules may be accessed from a separate rules database. The risk monitoring logic/routine 104 may include an advance block risk pattern identification logic/routine 140 which may access one or more blocking rules 144. The blocking rules may be integrated into the advance block risk pattern identification logic/routine 140 or the blocking rules may be accessed from a separate rules database.

In specific embodiments, the risk monitoring and mitigation module 123 may comprise a risk mitigation logic/routine 128. The risk monitoring and mitigation module 123 may be configured to execute the risk mitigation logic/routine 128 in response to identifying one or more risk patterns associated with an account. The risk mitigation logic/routine 128 may include a payment hold execution routine 152 which is executed in response to identifying a payment hold risk pattern. The risk mitigation logic/routine 128 may also include an advance block execution routine 160 which is executed in response to identifying an advance block risk pattern. The risk monitoring and mitigation module 123 may include other logic/routine 112 that perform additional risk monitoring, risk mitigation, risk alerting, or other supporting functions.

The risk alert logic/routine 107 may be configured to communicate risk identification alerts generated by the risk monitoring logic/routine 104. The risk alert logic/routine 107 may also be configured to communicate risk mitigation alerts generated by the risk mitigation logic/routine 128. The query logic/routine 108 may be configured to receive a query from personnel to allow the personnel to query an account to determine whether the account poses a risk such as a payment hold risk or an advance block risk. The query logic/routine 108 may also be configured to communicate the results of the query to an appropriate recipient. The risk alerts and query responses may be communicated via the communications module 60 which may invoke a communication channel, such as postal mail, email, Short Message Service (SMS)/text, voicemail or the like. In many instances the query responses and/or risk alerts may be configured to be communicated electronically either in real-time, near-real-time or periodic batch files to personnel, systems, databases, or the like.

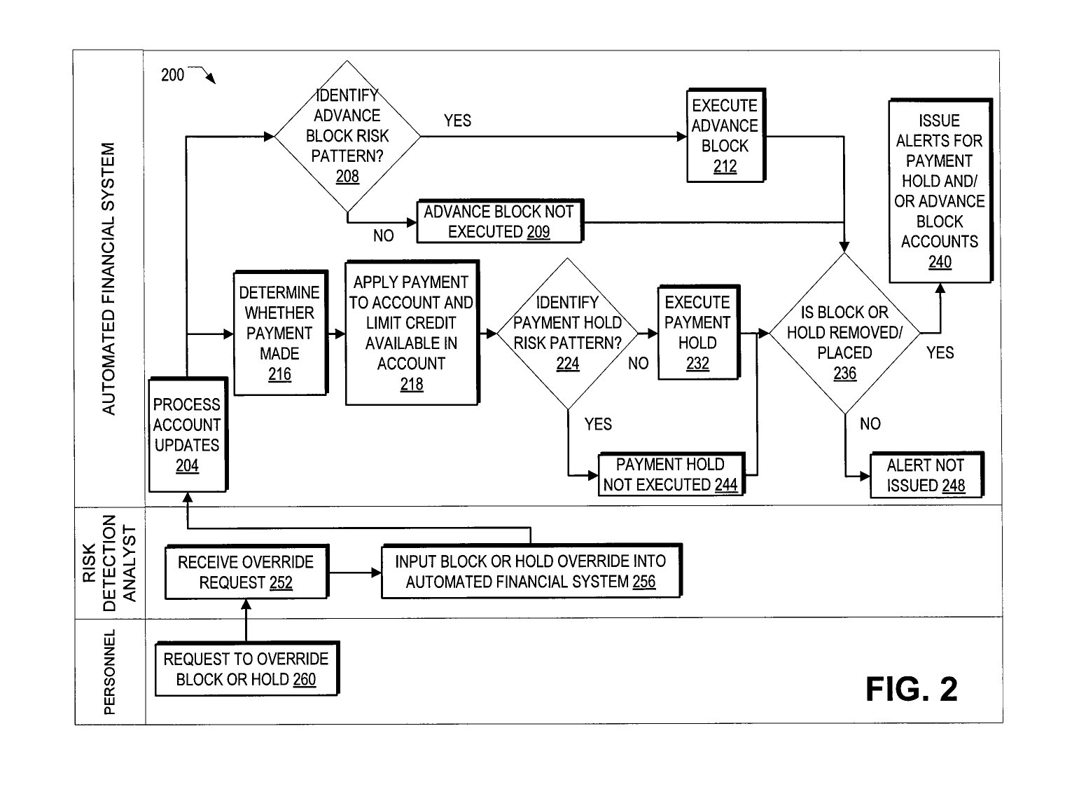

FIG. 2 is a detailed flowchart displaying the risk monitoring and mitigation method 200, in accordance with embodiments of the present invention. The various steps of the method may be executed via a computing device processor.

The process starts at block 204 of FIG. 2, where the system 12, in one embodiment of the invention, may access data associated with various accounts that are stored in a database, which is accessible by the system 12. In one embodiment, the system 12 may be an automated financial system as displayed in FIG. 2. In one embodiment, the system 12 may itself store the accounts. In one embodiment, these accounts may be credit accounts such that the clients associated with the accounts have repayment or delivery obligations where both principal and interest on the principal may be due under previously agreed upon terms and conditions. In one embodiment, the data associated with an account may include the previously described data that may be used to identify various risk patterns. For instance, the data may include the balance on the account, the status of the account, the length of any delinquency or overdue payment, the guarantors of an account, etc.

In one embodiment, the system 12 may periodically process account updates in a batch processing environment. Account updates may include a payment being made to an account or an advance being requested from an account. An advance may be a credit advance or a cash advance. In a batch processing embodiment, the system 12 may periodically update accounts once, or a fixed number of times, during a pre-determined period, such as a day, based on all the account data that was received throughout the pre-determined period. In one embodiment, the system 12 may be able to identify and select one or more accounts to exclude from the periodic account updates. Therefore, in such an embodiment, these excluded accounts may be excluded from the risk strategy processing described below. Subsequently, the system 12 may also produce any output files, such as account alerts, that may result from updating the accounts. In one embodiment, the system 12 may dynamically process account updates. In this embodiment, the system 12 may dynamically update a particular account when it receives data associated with that particular account.

### Advance Block Risk Monitoring and Mitigation Strategy

The process moves to block 208 of FIG. 2, where the system 12, in one embodiment of the invention, may monitor, via a computing device processor, the account data to identify one more risk patterns. In one embodiment, the system 12 may identify an advance block risk pattern. The advance block risk pattern may comprise one or more blocking rules that have to be satisfied in order for the system 12 to identify the advance block risk pattern. In one embodiment, the system 12 may identify the advance block risk pattern based on a single blocking rule, whereas in other embodiments, the system 12 may identify the advance block risk pattern based on more than one blocking rule. In one embodiment, the system 12 may apply a different set of blocking rules depending on the type of loan or product associated with the account.

In those embodiments where the system may identify the advance block risk pattern based on a single blocking rule, this blocking rule may relate to determining if the account is delinquent. In one embodiment, the account principal may be delinquent. In another embodiment, the interest due on the account may be delinquent. In one embodiment, the system may determine that the account is delinquent if a payment on the account has been due for a pre-determined number of days. In one embodiment, the pre-determined number of days may be determined dynamically for an account such that the pre-determined number of days for one account is different from the pre-determined number of days for another account. In one embodiment, the system 12 may not re-identify an advance block risk pattern for an account a pre-determined number of days after previously removing an advance block on the account.

The type of advance blocking rules are not limited to the advance blocking rules described here. There may be other advance blocking rules that are implemented into the system 12 that are not discussed here. Some or all of the criteria or rules that are used by the system 12 to determine whether an advance block risk exists for an account may also be used by the system 12 to determine whether a payment hold risk exists for the account.

If the system 12 does not identify an advance block risk pattern in block 208 of FIG. 2, then an advance block routine may not be executed as indicated by block 209 of FIG. 2.

If the system 12 identifies an advance block risk pattern in block 208 of FIG. 2, the process moves to block 212 of FIG. 2, where the system 12, in one embodiment of the invention, may execute an advance block routine. In one embodiment, the system 12 may automatically execute the advance block routine, whereas in another embodiment, the system 12 may execute the advance block routine after receiving an input from a user of the system 12. In one embodiment, the user may manually execute the advance block routine. A user of the system 12 may be a risk detection analyst, as described below, or other personnel, also as described below.

In one embodiment, the advance block routine may comprise automatically blocking a transaction related to the account. In one embodiment, the blocked transaction may be a credit advancing transaction. In one embodiment, the blocked transaction may be a cash advancing transaction. In one embodiment, the advance block routine may comprise automatically blocking an account from participating in one or more transactions. In one embodiment, the advance block routine may comprise a user manually placing, in the system 12, a block on a transaction related to the account. In one embodiment, the advance block routine may comprise a user manually placing, in the system 12, a block on an account in order to prevent the account from participating in one or more transactions. In one embodiment, the advance block routine may comprise automatically cutting off in the system 12 an account's credit line availability on a permanent basis, and forcing the term out of any remaining balance in the account. In one embodiment, the advance block routine may comprise a user manually cutting off, in the system 12, an account's credit line availability on a permanent basis and forcing the term out of any remaining balance in the account. In one embodiment, the account's credit line availability may be cut off regardless of any payments being made to the account. A user of the system 12 may be a risk detection analyst, as described below, or other personnel, also as described below.

At block 252 of FIG. 2, the risk detection analyst, in one embodiment of the invention, may receive a request from personnel at block 260 of FIG. 2 to manually override the blocked transaction or the blocked account in the system 12. In one embodiment, the risk detection analyst may be a human agent. In another embodiment, the risk detection analyst may be a computer or a bot. In one embodiment, the risk detection analyst may need to be authenticated into the system 12 in order to input manual overrides. The risk detection analyst, in response to receiving the request at block 252 of FIG. 2, may manually input into the system 12 the override to unblock the blocked transaction or unblock the blocked account. In one embodiment, the risk detection analyst at block 256 of FIG. 2, may manually input into the system 12, the override to unblock the blocked transaction or unblock the blocked account without receiving a request to override the blocked transaction or the blocked account. Personnel, as used herein, may refer to one or more persons or bots within an organization, entity, or the like associated with the system 12. In some embodiments, in addition to the risk detection analyst, other personnel may also be permitted to input manual overrides, or may have limited permission to input manual overrides only for specific accounts.

In one embodiment, the system 12 may initiate and communicate an error message to a client who attempts an advance on a blocked account. For instance, the system 12 may communicate this message to the client's computer who may view the message on a display screen.

In one embodiment of the invention, the system 12, in response to determining that the advance block risk pattern is removed, may automatically unblock a blocked account so that the account may participate in transactions. In one embodiment of the invention, the system 12, in response to determining that the advance block risk pattern is removed, may automatically unblock a blocked transaction related to an account, so that the transaction may now be executed.

### Payment Hold Risk Monitoring and Mitigation Strategy

The process path for identifying a first type of risk pattern and executing a routine to mitigate the first risk pattern may run parallel to the process path for identifying a second type of risk pattern and executing a routine to mitigate the second risk pattern. In one embodiment, as shown in FIG. 2, the process path for identifying an advance block risk pattern and executing an advance block routine may run parallel to and may be mutually exclusive of the process for identifying a payment hold risk pattern and executing a payment hold routine. Therefore, in one embodiment, the system 12 may identify more than one type of risk pattern associated with an account, and may execute more than one type of risk mitigation routine to mitigate the more than one type of identified risk patterns. Therefore, for instance, the system 12 may both block an advance associated with an account, as described above, and block a payment made to the account, as described below. In one embodiment, not shown in the Figures, the process path for identifying an advance block risk pattern may follow or may be followed by the process path for identifying a payment hold risk pattern.

In those embodiments involving a payment hold risk strategy, the system 12, at block 216 of FIG. 2, in one embodiment of the invention, may first determine whether a payment is made to an account.

In one embodiment, the process moves to block 218 where the system 12 may apply the payment to the account and may reduce a credit limit associated with the account. In one embodiment, the credit limit associated with the account may be reduced by the amount of the payment made in block 216. In one embodiment, the system 12 may apply the payment to the account and may block a credit line associated with the account.

The process then moves to block 224 of FIG. 2 where the system 12, in one embodiment of the invention, may monitor, via a computing device processor, the account data to identify one more risk patterns. In one embodiment, the system 12 may identify a payment hold risk pattern based on one or more holding rules. In one embodiment, the system 12 may identify the payment hold risk pattern based on a single holding rule, whereas in other embodiments, the system 12 may identify the payment hold risk pattern based on more than one holding rule. In one embodiment, the system 12 may apply a different set of holding rules depending on the type of loan or product associated with the account.

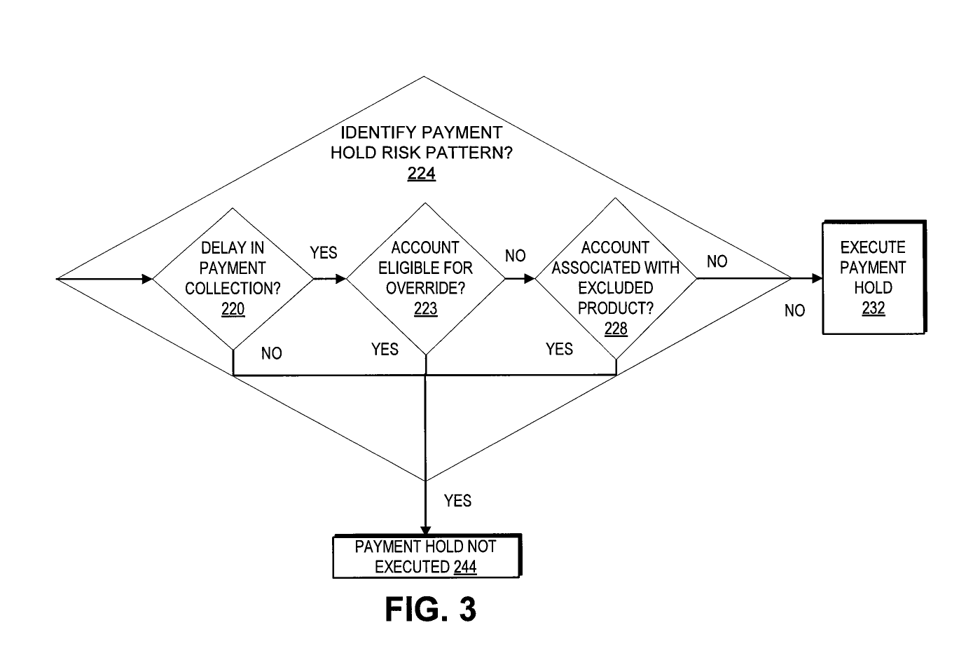

Block 224 of FIG. 2 is depicted in greater detail in FIG. 3.

In order to determine whether a payment hold risk pattern exists, the system 12 at block 220 of FIG. 3, in one embodiment of the invention, may determine whether there is a delay in collecting the payment made to the account. In one embodiment, the system 12 may determine that there is a delay in collecting the payment if the payment has not been collected for a pre-determined number of days. In one embodiment, the pre-determined number of days may be determined dynamically for an account such that the pre-determined number of days for one account is different from the pre-determined number of days for another account. In one embodiment, if there is a delay in collecting the payment made to the account, the process proceeds straight to block 232 where the system 12 may execute the payment hold routine. In one embodiment, if there is no delay in collecting the payment made to the account, the process may proceed to block 244 which indicates that the payment hold is not executed.

In one embodiment where there is a delay in payment collection at block 220 of FIG. 3, the process moves to block 223 of FIG. 3, where the system 12, in one embodiment of the invention, may determine whether the account is eligible for an override. A financial institution may establish one or more rules to determine whether an account is eligible for an override. In one embodiment, the system 12 may determine that the account is eligible for an override if the account is an account at the financial institution that manages the system 12. In one embodiment, if the account is not eligible for an override, the process proceeds straight to block 232 where the system 12 may execute the payment hold routine. In one embodiment, if the account is eligible for an override, the process may proceed to block 244 which indicates that the payment hold is not executed.

If one embodiment where the account is not eligible for an override at block 223 of FIG. 3, the process moves to block 228 of FIG. 3, where the system 12, in one embodiment of the invention, may determine whether the account to which the payment is made is associated with an excluded product. In one embodiment, the system 12 may determine that the account is associated with pre-determined types of loans. These pre-determined loans may be classified as excluded products because the risk associated with these loans may be below a certain risk threshold. In one embodiment, if the account is not associated with an excluded product, the process proceeds straight to block 232 where the system 12 may execute the payment hold routine. In one embodiment, if the account is associated with an excluded product, the process may proceed to block 244 which indicates that the payment hold is not executed.

In other embodiments of the invention, the system 12 may check whether one or more other holding rules are satisfied in order to identify whether a payment hold risk pattern exists. One or more of these other holding rules may need to be satisfied in conjunction with one or more of the holding rules described above in order for the system 12 to identify a payment hold risk pattern. The type of payment holding rules are not limited to the payment hold rules described here. There may be other payment holding rules that are implemented into the system 12 that are not discussed here.

As a further instance of another holding rule, in some embodiments, the system 12, in one embodiment of the invention, may be configured to determine the source of the payment. If the system 12 determines that the payment source account is an account at the same financial institution that manages the system 12, then the system 12 may be able to verify if there are sufficient funds in the source account. If there are sufficient funds in the source account, the system 12 may not identify a payment hold risk pattern, and may not consequently execute a payment hold even if there is a delay in collecting the payment made to the account.

As a further instance of another holding rule, in some embodiments, the system 12 may determine how the size of the current payment made compares to sizes of payments made during a pre-determined period in the past. If the payment size is similar to sizes of payments made in the past, the system 12 may not identify a payment hold risk pattern. If the payment size is larger by a pre-determined percentage amount than sizes of payments made in the past, then the system 12 may identify a payment hold risk pattern. In some embodiments, the system 12 may also consider the period of time that the account has been open in determining whether a payment hold risk exists. In some embodiments, the system 12 may also consider the financial obligation remaining on the account in determining whether a payment hold risk exists. In some embodiments, the system 12 may also consider the total of all payments made on the account. In some embodiments, the system 12 may also consider the number of payments made on time during a pre-determined period of time in the past and the number of payments not made on time during a pre-determined period in the past. In some embodiments, the system 12 may also consider how soon after a due date a payment was made on one or more occasions during a pre-determined period in the past. In some embodiments, the system 12 may also consider the size of the largest or smallest payments made during a pre-determined period in the past, and how those payments compare to the current payment. In some embodiments, the system 12 may also consider the number of payments returned for any reason other than error on the part of the financial institution that manages the account during a pre-determined period in the past. In some embodiments, the system 12 may also consider whether the loan or product associated with an account is secured or unsecured.

Some or all of the above-described criteria or rules that are used by the system 12 to determine whether a payment hold risk exists for an account may also be used by the system 12 to determine whether an advance block risk exists for the account.

If the system 12 identifies a payment hold risk pattern in block 224 of FIG. 2, the process moves to block 232 of FIG. 2, where the system 12, in one embodiment of the invention, may execute a payment hold routine. In one embodiment, the system 12 may automatically execute the payment hold routine, whereas in another embodiment, the system 12 may execute the payment hold routine after receiving an input from a user of the system 12. In one embodiment, the user may manually execute the payment hold routine. A user of the system 12 may be a risk detection analyst, as described below, or other personnel, also as described below.

If the system 12 does not identify a payment hold risk pattern in block 224 of FIG. 2, then a payment hold routine may not be executed as indicated by block 244 of FIG. 2.

In one embodiment, the payment hold routine may comprise automatically holding a payment made to an account. In one embodiment, the payment hold routine may comprise a user manually placing, in the system 12, a hold on a payment made to the account. A user of the system 12 may be a risk detection analyst, as described below, or other personnel, also as described below.

At block 252 of FIG. 2, the risk detection analyst, in one embodiment of the invention, may receive a request from personnel at block 260 of FIG. 2 to manually override the withheld payment. In one embodiment, the risk detection analyst may be a human agent. In another embodiment, the risk detection analyst may be a computer or a bot. The risk detection analyst, in response to receiving the request at block 252 of FIG. 2, may manually input into the system 12 the override to release the withheld payment. In one embodiment, the risk detection analyst at block 256 of FIG. 2, may manually input into the system 12, the override to release the withheld payment without receiving a request to release the withheld payment. Personnel, as used herein, may refer to one or more persons or bots within an organization, entity, or the like associated with the system 12.

In one embodiment, the system 12 may initiate and communicate an error message to a client who attempts to access the credit line of an account associated with a payment hold. For instance, this message may be communicated to the client's computer who may view the message on a display screen. In an embodiment, the system 12 may only initiate and communicate an error message to a client who attempts to access an amount greater than the reduced credit limit associated with the account. The reduced credit limit has been described earlier in this section.

In one embodiment of the invention, the system 12, in response to determining that the payment hold risk pattern is removed, may automatically remove the hold on the payment made to the account. In one embodiment of the invention, the system 12, in response to determining that the payment hold risk pattern is removed, may automatically raise the reduced credit limit of the account. In one embodiment, the reduced credit limit may have to be raised by manually entering input into the system 12. In one embodiment of the invention, the system 12 may automatically remove, after a pre-determined period of holding time, a payment hold on a payment made to an account, regardless of whether the payment hold risk pattern has been removed and regardless of whether the payment has been cleared or collected. When the payment hold is removed after a pre-determined period of holding time, the reduced credit limit may be raised and the client may have access to the original credit line associated with the account.

### Risk Communication

The process moves to block 236 of FIG. 2, where the system 12, in one embodiment of the invention, may determine whether an advance block or a payment hold is placed or executed with respect to an account, according to embodiments described previously. At block 236 of FIG. 2, the financial system 12, may also determine whether an advance block or a payment hold that had been previously executed is removed with respect to an account, according to embodiments described previously.

If the system 12 determines that an advance block or a payment hold is placed or removed with respect to an account, the process moves to block 240 of FIG. 2 where the system 12, in one embodiment of the invention, may issue an alert for an account associated with either placing or removing an advance block or a payment hold. In one embodiment, the alert may be an electronic file. The risk alert logic/routine is represented by block 107 in FIG. 1. In one embodiment, the alert may be generated dynamically and sent immediately, via a computing device processor and via communication methods described earlier, to the appropriate personnel when an advance block routine or a payment hold routine is executed, or when an advance block or a payment hold is removed either manually or automatically with respect to an account. The appropriate personnel may pursue further review or investigation of the account. Alternatively, in a batch processing embodiment, the alerts for a plurality of accounts that are associated with either placing or removing advance blocks or payment holds may be both generated and sent to personnel on a periodic basis. In this embodiment, the system 12 may include in periodic, e.g., daily, electronic notices to personnel, those accounts associated with either placing or removing advance blocks or payment holds. The electronic notification may be processed according to the communication means that have been described earlier. In one embodiment where the appropriate personnel are client managers, the system 12 may include in separate periodic, e.g., daily, electronic notices to each client manager, the client manager's clients who have accounts associated with either placing or removing advance blocks or payment holds. The notification for each affected account may include the name on the account, the reference number of the account, the balance due on the account, the due date of a periodic payment, the date the account was opened, the name of the manager in charge of the client's account, and other financial institution data as described earlier. This financial institution data may include the payment history, payment sizes of both current and past payments, payment sources of both current and past payments, payment due dates and whether the client is meeting the payment due dates, the number of days overdue if a payment is overdue, whether any past payments have been returned, the type of loan or product associated with the account, whether the loan product is unsecured or secured, the guarantors of an account, etc. The notification may also include the type of risk pattern that was identified, the severity of the risk, the amount of the payment hold and/or the reduced credit limit if a payment hold was executed, the payment hold expiration date, the reason for executing the payment hold if a payment hold was executed, the unused amount and the reason for executing an advance block if an advance block was executed, the reason for returning a payment to a payment source if a payment was returned, etc. In one embodiment, the unused amount is the unused amount of a credit line associated with an account.

In some embodiments, the system 12 may communicate a risk alert to an appropriate user when a risk pattern, such as a payment hold risk pattern or an advance block risk pattern, is identified for an account. In such embodiments, the system 12 may then allow the appropriate user to determine the type of risk mitigation action, if any at all, to be executed with respect to the account. The type of risk mitigation actions have been described previously.

In some embodiments, the system 12 may also communicate a message to the client associated with an account when a risk pattern, such as a payment hold risk pattern or an advance block risk pattern, is identified for the account. In some embodiments, the system 12 may also communicate a message to a client when a risk mitigation action is executed with respect to the account.

The system 12 may also allow personnel to query an account to determine whether the account poses a risk such as a payment hold risk or an advance block risk. The query logic/routine is represented by block 108 in FIG. 1. In one embodiment, the system 12 may also allow personnel to query more than one account in the same query. In one embodiment, the system 12 may also allow personnel to customize the risk identification rules, i.e., modify the blocking or holding rules, in their queries in order to determine whether the queried account poses a risk based on the customized risk identification rules. The system 12 may electronically deliver, according the embodiments described above, the results of the query to the recipient specified in the query, and allow the recipient to view the results of a query via an electronic display.

Thus, present embodiments disclosed in detail above provide systems, methods and computer program products for identifying, based on a plurality of rules, risk patterns for accounts, and executing risk mitigation routines for those accounts for which risk patterns have been identified.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for risk monitoring and mitigation at a system, the method comprising:
receiving, via a computing device processor, account data for an account;
monitoring, via a computing device processor, the account data to identify one or more risk patterns;
identifying, via a computing device processor, the one or more risk patterns;
in response to identifying, via a computing device processor, an advance block risk pattern based on at least on one blocking rule, automatically executing, via a computing device processor, an advance block routine; and
in response to identifying, via a computing device processor, a payment hold risk pattern based on at least one holding rule, automatically executing, via a computing device processor, a payment hold routine.

2. The method of claim 1, wherein identifying a payment hold risk pattern based on at least one holding rule further comprises:
determining, via a computing device processor, whether a payment is made to the account;
in response to determining the payment is made to the account, determining, via a computing device processor, whether there is a delay in collecting the payment;
determining, via a computing device processor, whether the account is eligible for an override; and
determining, via a computing device processor, whether the account is associated with an excluded product.

3. The method of claim 1, wherein identifying an advance block risk pattern based on at least one blocking rule further comprises:
determining, via a computing device processor, whether the account is delinquent, wherein the account is delinquent if a payment on the account has been due for a pre-determined number of days.

4. The method of claim 1, further comprising:
in response to executing either the advance block routine or the payment hold routine, automatically generating and initiating communication of, via a computing device processor, a risk alert for the account.

5. The method of claim 1, further comprising periodically updating, via a computing device processor, the account data for the account.

6. The method of claim 1, wherein executing the advance block routine further comprises:
automatically blocking, via a computing device processor, the account from participating in one or more transactions.

7. The method of claim 6, wherein a transaction from the one or more transactions is a credit advancing transaction.

8. The method of claim 1, wherein executing the advance block routine further comprises:
allowing a user to place, in the system, via a computing device processor, a block on the account that prevents the account from participating in one or more transactions.

9. The method of claim 1, wherein executing the advance block routine further comprises:
allowing a user to cut off, in the system, via a computing device processor, the account's credit line availability on a permanent basis; and
forcing, via a computing device processor, the term out of a remaining balance in the account.

10. The method of claim 6, further comprising:
allowing a user to override, in the system, via a computing device processor, the blocked account.

11. The method of claim 6, further comprising:
receiving a request to override the blocked account; and
in response to receiving the request, allowing a user to override, in the system, the blocked account.

12. The method of claim 6, further comprising:
determining, via a computing device processor, whether the advance block risk pattern is removed;
in response to determining the advance block risk pattern is removed, automatically unblocking the account via a computing device processor; and
in response to unblocking the account, automatically generating and initiating communication of, via a computing device processor, a risk alert for the account.

13. The method of claim 1, wherein executing the payment hold routine further comprises:
determining, via a computing device processor, a payment is made to the account; and
automatically holding, via a computing device processor, the payment made to the account.

14. The method of claim 13, further comprising:
in response to determining the payment is made to the account, applying, via a computing device processor, the payment to the account; and
reducing, via a computing device processor, a credit limit of the account,
wherein the credit limit is reduced by the amount of the payment.

15. The method of claim 1, wherein executing the payment hold routine further comprises:
allowing a user to place, in the system, via a computing device processor, a hold on a payment made to the account.

16. The method of claim 13, further comprising:
allowing a user to override, in the system, via a computing device processor, the hold on the payment.

17. The method of claim 13, further comprising:
receiving, via a computing device processor, a request to override the hold on the payment; and
in response to receiving the request, allowing a user to override, in the system, via a computing device processor, the hold on the payment.

18. The method of claim 13, further comprising:
determining, via a computing device processor, whether the payment hold risk pattern is removed;
in response to determining that the payment hold risk pattern is removed, automatically removing, via a computing device processor, the hold on the payment; and
in response to removing the hold on the payment, automatically generating and initiating communication of, via a computing device processor, a risk alert for the account.

19. The method of claim 14, further comprising:
determining, via a computing device processor, whether the payment hold risk pattern is removed; and
in response to determining that the payment hold risk pattern is removed, automatically raising, via a computing device processor, the reduced credit limit of the account.

20. A system for risk monitoring and mitigation, the system comprising:
a computing platform including at least one computing device processor and a memory;
a module stored in the memory, executable by a computing device processor, and configured to:
receive, via a computing device processor, account data for an account;
monitor, via a computing device processor, the account data to identify one or more risk patterns;
identify, via a computing device processor, the one or more risk patterns;
in response to identifying an advance block risk pattern based on at least on one blocking rule, automatically execute, via a computing device processor, an advance block routine; and
in response to identifying a payment hold risk pattern based on at least one holding rule, automatically execute, via a computing device processor, a payment hold routine.

21. The system of claim 20, wherein the module configured to identify a payment hold risk pattern based on at least one holding rule further comprises the module configured to:
determine, via a computing device processor, whether a payment is made to the account;
in response to determining the payment is made to the account, determine, via a computing device processor, whether there is a delay in collecting the payment;
determine, via a computing device processor, whether the account is eligible for an override; and
determine, via a computing device processor, whether the account is associated with an excluded product.

22. The system of claim 20, wherein the module configured to identify an advance block risk pattern based on at least on one blocking rule further comprises the module configured to:
determine, via a computing device processor, whether the account is delinquent, wherein the account is delinquent if a payment on the account has been due for a pre-determined number of days.

23. The system of claim 20, wherein the module is further configured to:
in response to executing either the advance block routine or the payment hold routine, automatically generate and initiate communication of, via a computing device processor, a risk alert for the account.

24. The system of claim 20, wherein the module is further configured to periodically update the account data for the account.

25. The system of claim 20, wherein the module configured to execute the advance block routine is further configured to:
automatically block, via a computing device processor, the account from participating in one or more transactions.

26. The system of claim 25, wherein a transaction from the one or more transactions is a credit advancing transaction.

27. The system of claim 20, wherein the module configured to execute the advance block routine is further configured to:
allow a user to place, in the system, via a computing device processor, a block on the account that prevents the account from participating in one or more transactions.

28. The system of claim 20, wherein the module configured to execute the advance block routine is further configured to:
allow a user to cut off, in the system, via a computing device processor, the account's credit line availability on a permanent basis; and
force, via a computing device processor, the term out of a remaining balance in the account.

29. The system of claim 25, wherein the module is further configured to:
allow a user to override, in the system, via a computing device processor, the blocked account.

30. The system of claim 25, wherein the module is further configured to:
receive, via a computing device processor, a request to override the blocked account; and
in response to receiving the request, allow a user to override, in the system, via a computing device processor, the blocked account.

31. The system of claim 25, wherein the module is further configured to:
determine, via a computing device processor, whether the advance block risk pattern is removed;
in response to determining the advance block risk pattern is removed, automatically unblock the account via a computing device processor; and
in response to unblocking the account, automatically generate and initiate communication of, via a computing device processor, a risk alert for the account.

32. The system of claim 20, wherein the module configured to execute the payment hold routine is further configured to:
determine, via a computing device processor, a payment is made to the account; and
automatically hold, via a computing device processor, the payment made to the account.

33. The system of claim 32, wherein the module is further configured to:
in response to determining the payment is made to the account, apply, via a computing device processor, the payment to the account; and
reduce, via a computing device processor, a credit limit of the account,
wherein the credit limit is reduced by the amount of the payment.

34. The system of claim 20, wherein the module configured to execute the payment hold routine is further configured to:
allow a user to place, in the system, via a computing device processor, a hold on a payment made to the account.

35. The system of claim 32, wherein the module is further configured to:
allow a user to override, in the system, via a computing device processor, the hold on the payment.

36. The system of claim 32, wherein the module is further configured to:
receive, via a computing device processor, a request to override the hold on the payment; and
in response to receiving the request, allow a user to override, in the system, via a computing device processor, the hold on the payment.

37. The system of claim 32, wherein the module is further configured to:
determine, via a computing device processor, whether the payment hold risk pattern is removed;
in response to determining that the payment hold risk pattern is removed, automatically remove, via a computing device processor, the hold on the payment; and
in response to removing the hold on the payment, automatically generate and initiate communication of, via a computing device processor, a risk alert for the account.

38. The system of claim 33, wherein the module is further configured to:
determine, via a computing device processor, whether the payment hold risk pattern is removed;
in response to determining that the payment hold risk pattern is removed, automatically raise, via a computing device processor, the reduced credit limit of the account.

39. A computer program product for risk monitoring and mitigation at a system, the computer program product comprising:
a non-transitory computer-readable medium comprising a set of codes for causing a computer to:
receive, via a computing device processor, account data for an account;
monitor, via a computing device processor, the account data to identify one or more risk patterns;
identify, via a computing device processor, the one or more risk patterns;
in response to identifying an advance block risk pattern based on at least on one blocking rule, automatically execute, via a computing device processor, an advance block routine; and
in response to identifying a payment hold risk pattern based on at least one holding rule, automatically execute, via a computing device processor, a payment hold routine.

40. The computer program product of claim 39, wherein the set of codes causing a computer to identify a payment hold risk pattern based on at least one holding rule further comprises the set of codes causing a computer to:
determine, via a computing device processor, whether a payment is made to the account;
in response to determining the payment is made to the account, determine, via a computing device processor, whether there is a delay in collecting the payment;
determine, via a computing device processor, whether the account is eligible for an override; and
determine, via a computing device processor, whether the account is associated with an excluded product.

41. The computer program product of claim 39, wherein the set of codes causing a computer to identify an advance block risk pattern based on at least on one blocking rule further comprises the set of codes causing a computer to:
determine, via a computing device processor, whether the account is delinquent, wherein the account is delinquent if a payment on the account has been due for a pre-determined number of days.

42. The computer program product of claim 39, wherein the set of codes further causes a computer to:
in response to executing either the advance block routine or the payment hold routine, automatically generate and initiate communication of, via a computing device processor, a risk alert for the account.

43. The computer program product of claim 39, wherein the set of codes further causes a computer to periodically update, via a computing device processor, the account data for the account.

44. The computer program product of claim 39, wherein the set of codes causing a computer to execute the advance block routine further causes a computer to:
automatically block, via a computing device processor, the account from participating in one or more transactions.

45. The computer program product of claim 44, wherein a transaction from the one or more transactions is a credit advancing transaction.

46. The computer program product of claim 39, wherein the set of codes causing a computer to execute the advance block routine further causes a computer to:
allow a user to place, in the system, via a computing device processor, a block on the account that prevents the account from participating in one or more transactions.

47. The computer program product of claim 39, wherein the set of codes causing a computer to execute the advance block routine further causes a computer to:
allow a user to cut off, in the system, via a computing device processor, the account's credit line availability on a permanent basis; and
force, via a computing device processor, the term out of a remaining balance in the account.

48. The computer program product of claim 44, wherein the set of codes further causes a computer to:
allow a user to override, in the system, via a computing device processor, the blocked account.

49. The computer program product of claim 44, wherein the set of codes further causes a computer to:
receive, via a computing device processor, a request to override the blocked account; and
in response to receiving the request, allow a user to override, in the system, via a computing device processor, the blocked account.

50. The computer program product of claim 44, wherein the set of codes further causes a computer to:
determine, via a computing device processor, whether the advance block risk pattern is removed;
in response to determining the advance block risk pattern is removed, automatically unblock the account via a computing device processor; and
in response to unblocking the account, automatically generate and initiate communication of, via a computing device processor, a risk alert for the account.

51. The computer program product of claim 39, wherein the set of codes causing a computer to execute the payment hold routine further causes a computer to:
determine, via a computing device processor, a payment is made to the account; and
automatically hold, via a computing device processor, the payment made to the account.

52. The computer program product of claim 51, wherein the set of codes further causes a computer to:
in response to determining the payment is made to the account, apply, via a computing device processor, the payment to the account; and
reduce, via a computing device processor, a credit limit of the account,
wherein the credit limit is reduced by the amount of the payment.

53. The computer program product of claim 39, wherein the set of codes causing a computer to execute the payment hold routine further causes a computer to:
allow a user to place, in the system, via a computing device processor, a hold on a payment made to the account.

54. The computer program product of claim 51, wherein the set of codes further causes a computer to:
allow a user to override, in the system, via a computing device processor, the hold on the payment.

55. The computer program product of claim 51, wherein the set of codes further causes a computer to:
receive, via a computing device processor, a request to override the hold on the payment; and
in response to receiving the request, allow a user to override, in the system, via a computing device processor, the hold on the payment.

56. The computer program product of claim 51, wherein the set of codes further causes a computer to:
determine, via a computing device processor, whether the payment hold risk pattern is removed;
in response to determining that the payment hold risk pattern is removed, automatically remove, via a computing device processor, the hold on the payment; and
in response to removing the hold on the payment, automatically generate and initiate communication of, via a computing device processor, a risk alert for the account.

57. The computer program product of claim 52, wherein the set of codes further causes a computer to:
determine, via a computing device processor, whether the payment hold risk pattern is removed; and
in response to determining that the payment hold risk pattern is removed, automatically raise the reduced credit limit of the account.
